(19) United States
(12) Patent Application Publication
(10) Pub. No.: US 2023/0068379 A1
(43) Pub. Date: Mar. 2, 2023

(54) SPINDLE MOTOR AND HARD DISK DRIVE DEVICE

(71) Applicant: MINEBEA MITSUMI Inc., Nagano (JP)

(72) Inventors: Hideaki SHOWA, Kitasaku-gun (JP); Daisuke ITO, Kitasaku-gun (JP)

(21) Appl. No.: 17/820,069

(22) Filed: Aug. 16, 2022

(30) Foreign Application Priority Data
Aug. 27, 2021 (JP) 2021-138866

(51) Int. Cl. G11B 19/20; G11B 33/02; H02K 1/02

(52) U.S. Cl. CPC G11B 19/2045; G11B 33/022; H02K 1/02; G11B 2220/2516

(57) ABSTRACT

A spindle motor configured to be used for a hard disk drive device with a gas having a density lower than a density of air sealed in an internal space includes a rotor magnet. The rotor magnet has a radial thickness of 1.0 to 1.4 mm and a density of 5.6 to 6.0 g/cm³.

### CROSS REFERENCE TO RELATED APPLICATIONS

This application claims the benefit of priority to Japanese Patent Application Number 2021-138866 filed on Aug. 27, 2021. The entire contents of the above-identified application are hereby incorporated by reference.

### TECHNICAL FIELD

The disclosure relates to a spindle motor and a hard disk drive device, and particularly to a technique for reducing the demagnetization of a mounted magnet.

### BACKGROUND

A known rotor magnet of a spindle motor in a hard disk drive device uses a neodymium magnet (Nd—Fe—B magnet) (see, for example, JP 2008-187854 A).

### SUMMARY

For a hard disk drive device (hereinafter, also abbreviated as “HDD”) with a low-density gas such as helium sealed, corrosion of the magnet is accelerated due to the effect of humidity in a sealed space without air circulation with the outside, progressing demagnetization in a hot environment more than in an air environment. On the other hand, a sealed space having a low relative humidity of, for example, less than 35% RH, has electro static discharge easily caused.

When the operating temperature of the hard disk drive device is around 60° C. and the relative humidity in the sealed space falls below a relative humidity at normal temperature, the relative humidity easily causes an electro static discharge. Therefore, in the related art, to increase relative humidity to the extent that the electro static discharge can be prevented, moisture is sometimes added in a sealed space. In this case, unfortunately, when the amount of moisture to be replenished exceeds an appropriate amount, the magnet easily comes into contact with water vapor. Also, the hard disk drive device with helium sealed may have an internal pressure less than one atmosphere, moisture is likely to evaporate under such a low-pressure environment, and the magnet easily comes into contact with water vapor.

The disclosure has been made in view of the above circumstances. An object of the disclosure is to provide a spindle motor and a hard disk drive device, capable of suppressing demagnetization of a magnet and extending a lifetime by suppressing corrosion due to water vapor of a magnet to be installed in a hard disk drive device with a low-density gas sealed.

A spindle motor configured to be used for a hard disk drive device with a gas having a density lower than a density of air sealed in an internal space according to the disclosure includes a rotor magnet and has a radial thickness of 1.0 to 1.4 mm and a density of 5.6 to 6.0 g/cm³.

Further, a spindle motor configured to be used for a hard disk drive device with a gas having a density lower than a density of air sealed in an internal space according to the disclosure includes a rotor magnet. The rotor magnet is an Nd—Fe—B—Nb—based magnet, and Nb contained in the rotor magnet is in a ratio of 1.5 to 3.0 mass% to a total mass of the rotor magnet.

The disclosure provides a spindle motor and a hard disk drive device configured to suppress corrosion due to water vapor of a magnet to be installed in a hard disk drive device with a low-density gas sealed, to suppress demagnetization of the magnet and allow a lifetime to be extended.

### BRIEF DESCRIPTION OF DRAWINGS

FIG. 1 is a perspective view illustrating a hard disk drive device according to an embodiment of the disclosure.

FIG. 2 is a cross-sectional view illustrating a hard disk drive device according to an embodiment of the disclosure.

FIG. 3 is a cross-sectional view illustrating a spindle motor according to an embodiment of the disclosure.

### DESCRIPTION OF EMBODIMENTS

### 1. Hard Disk Drive Device

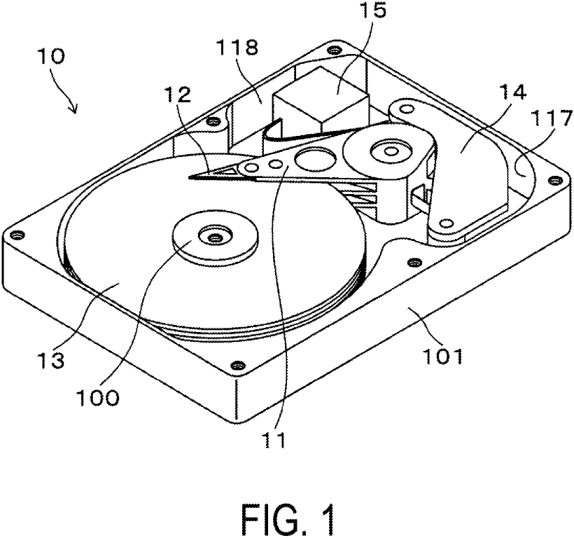

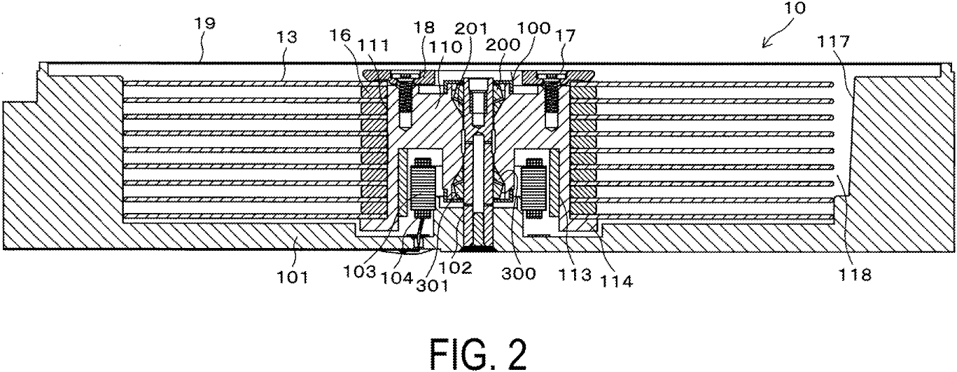

FIG. 1 is a cross-sectional view illustrating an overall configuration of a hard disk drive device 10 using a spindle motor according to an embodiment of the disclosure. FIG. 2 is a sectional view taken along a plane including a rotation axis. As illustrated in these drawings, the hard disk drive device 10 forms a housing 118 in a base part 101 having a recess part 117, and includes, in the housing 118, a spindle motor 100 and a plurality of hard disks 13 attached to the spindle motor 100 and rotating. The hard disk drive device 10 includes a swing arm 11 for supporting a plurality of magnetic heads 12 opposed to the respective hard disks 13, an actuator 14 for driving the swing arm 11, and a control unit 15 for controlling these devices. The hard disk drive device 10 forms an enclosure including a cover part (not illustrated) to be attached to the base part 101 to seal the housing 118, and the base part 101. Helium is sealed in the enclosure.

### 2. Spindle Motor

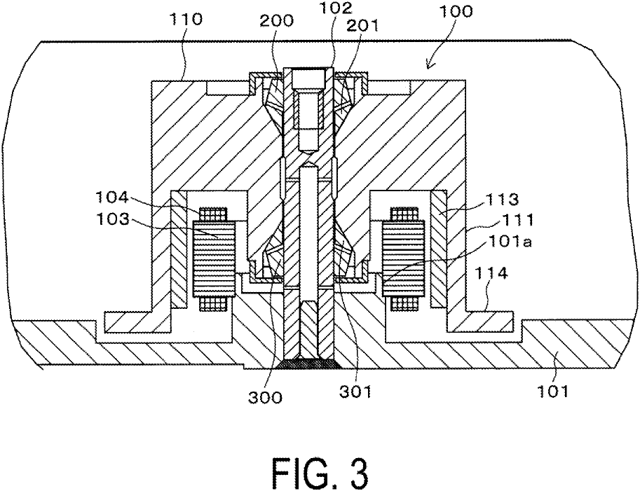

FIG. 3 is a cross-sectional view of a spindle motor 100 according to an embodiment cut in a plane including a rotation axis. The spindle motor 100 includes a base part 101 and a shaft 102 fixed to the base part 101. Conical bearing members 201 and 301 are fixed to the shaft 102 separated from each other in an axial direction, constituting bearings 200 and 300, respectively.

A cylindrical part 101a extending upward in the axial direction of the shaft 102 is formed in the base part 101, and a stator core 103 is fixed to the outer periphery of the cylindrical part 101a. The stator core 103 is formed by stacking a plurality of thin plate-like soft magnetic materials (e.g., electromagnetic steel plates) having an annular shape in the axial direction and is provided with a plurality of pole teeth protruding outward in the radial direction. The plurality of pole teeth is provided at equal intervals along the circumferential direction, and each pole tooth is wound around with a coil 104.

The rotating part of the spindle motor 100 is provided with a rotor 110. The rotor 110 includes a cylindrical part 111, and a rotor magnet 113 having an annular shape is fixed to the inner peripheral surface side of the cylindrical part 111. The rotor magnet 113 is magnetized such that adjacent parts have alternately opposite polarities S, N, S, N... along a circumferential direction. The rotor magnet 113 will be described later in detail. The inner periphery of the rotor magnet 113 is opposed to the outer periphery of the pole teeth of the stator core 103 with a gap. Supplying a driving current to the coil 104 generates a driving force for rotating the rotor magnet 113, and the rotor 110 rotates about the shaft 102 as an axis with respect to the shaft 102 and the base part 101. This principle is similar to the principle of a typical spindle motor.

A flange part 114 extending radially outward is formed at the circumferential edge of the lower end part of the cylindrical part 111. The flange part 114 functions as a disk mounting part for stacking and mounting a plurality of hard disks 13. As illustrated in FIG. 2, hard disks 13 are mounted on the flange part 114. The hard disks 13 are stacked one after another via respective spacers 16, and a total of nine hard disks 13 are stacked. Additionally, the number of hard disks 13 does not have to be nine but may be nine or more. The hard disk 13 at the top is fixed to the rotor 110 by a clamp 18 attached to the upper surface of the rotor 110 by a screw 17.

### 3. Details of Rotor Magnet

The rotor magnet 113 is an Nd—Fe—B—Nb—based magnet having a radial thickness of 1.0 to 1.4 mm and a density of 5.6 to 6.0 g/cm³. The Nb contained in the rotor magnet 113 is 1.5 to 3.0 mass% with respect to the total mass of the rotor magnet 113. The reasons for these numerical limitations are described below.

### Thickness: 1.0 to 1.4 mm

As the rotor magnet 113 gets thicker, the effect of corrosion (water vapor) is more difficult to reach the internal magnetic powder, and demagnetization is more difficult because the permeance coefficient is high. According to examination by the inventor, it is confirmed that the demagnetizing factor greatly increases when the thickness of the rotor magnet 113 is less than 1.0 mm. Accordingly, the thickness of the rotor magnet 113 is set to 1.0 mm or more. On the other hand, the hard disk drive device sealed with helium has the increased capacity and the increased number of hard disks 13, thus increasing the length of the cylindrical part 111 in the axial direction. This increases the effect of the torque of the clamp 18 pressing the hard disk 13 at the top on the assembling accuracy of the hard disk 13. Thus, to increase rigidity by keeping the thickness of the cylindrical part 111 of the rotor 110, the upper limit of the thickness of the rotor magnet 113 is set to 1.4 mm. Accordingly, the thickness of the rotor magnet 113 is set to 1.0 to 1.4 mm. The thickness of the rotor magnet 113 is more preferably 1.05 to 1.25 mm.

### Density: 5.6 to 6.0 g/cm³

To obtain the magnetic flux density required for the rotor magnet 113, the density of the rotor magnet 113 requires 5.6 g/cm³ or more. On the other hand, as the density of the rotor magnet 113 is increased, the surface area is increased by cracking of individual magnetic particles during compression molding, and thus demagnetization due to corrosion is likely to occur. According to examination by the inventor, it is confirmed that the demagnetizing factor greatly increases when the density of the rotor magnet 113 exceeds 6.0 g/cm³. Accordingly, the density of the rotor magnet 113 is set to 5.6 to 6.0 g/cm³. The density of the rotor magnet 113 is more preferably 5.75 to 5.95 g/cm³.

### Content of Nb: 1.5 to 3.0 Mass%

Nb is an effective element for enhancing the corrosion resistance and coercive force of neodymium magnets and reducing the demagnetizing factor. The content of Nb less than 1.5 mass% with respect to the total amount of the rotor magnet 113 has difficulty in obtaining such an effect. On the other hand, the content of Nb exceeding 3.0 mass% causes too large coercive force and thus has difficulty in obtaining a necessary magnetic flux density within a range of usable magnetization conditions (magnetization voltage and current). Accordingly, the content of Nb is set to 1.5 to 3.0 mass%. The content of Nb is more preferably 1.7 to 2.8 mass%.

### Coating Film

The surface of the rotor magnet 113 is preferably coated with a coating film. The coating film allows permeation of water vapor from the surface to the inside to be suppressed. The coating film can be formed by electrolytic coating, powder coating, or electrolytic or electroless nickel plating. When the coating film is too thick, a plurality of coating or plating steps is required, and thus the thickness is preferably 10 to 35 µm and more preferably 15 to 25 µm.

### 4. Operation and Effects

In the hard disk drive device 10 provided with the rotor magnet 113, helium is sealed in the enclosure, the inside of the enclosure is blocked from air flow with the outside, and water vapor in the enclosure comes into contact with the rotor magnet 113. In the hard disk drive device 10 having the above configuration, the radial thickness of the rotor magnet 113 is 1.0 to 1.4 mm, the density of the rotor magnet 113 is 5.6 to 6.0 g/cm³, and corrosion of the rotor magnet 113 is suppressed, suppressing demagnetization. This allows the lifetime of the hard disk drive device 10 to be extended. Further, the radial thickness of the rotor magnet 113 is set to 1.4 mm or less, allowing the cylindrical part 111 of the rotor 110 to be kept and the rigidity to be increased.

In the hard disk drive device 10 having the above configuration, the content of Nb is 1.5 to 3.0 mass% with respect to the total amount of the rotor magnet 113, causing corrosion of the rotor magnet 113 to be suppressed and demagnetization to be suppressed. This allows the lifetime of the hard disk drive device 10 to be extended.

### 5. Modified Examples

The disclosure is not limited to the above embodiments, and various modifications can be made as follows.
i) Of a condition that the radial thickness of the rotor magnet 113 is 1.0 to 1.4 mm and the density of the rotor magnet 113 is 5.6 to 6.0 g/cm³ and a condition that the Nb contained in the rotor magnet 113 is in a ratio of 1.5 to 3.0 mass% to a total mass of the rotor magnet 113, only one may be satisfied.
ii) The Nd—Fe—B—Nb—based magnet may contain, in addition to Nb, an alkali metal element such as Li or Na, an alkaline earth metal element such as Be or Mg, a metal element such as Zr, Ti, V, W, Cr, Ni, Zn, Mo, Cu, Co, or Mn, a semimetal element such as Al or Si, and a non-metal element such as N or F.

### Examples

The effects of the disclosure will be described in detail with reference to specific embodiments.

### 1. Preparation of Hard Disk Drive Device

The ring-shaped rotor magnets with the content of Nb and the radial thickness shown in Table 1 were prepared. The density of the rotor magnet was measured by the method according to JIS Z 8807: 2012 “9 Methods of measuring Density and Specific Gravity by Geometric Measurement.” The measured densities are shown in Table 1.

The hard disk drive device illustrated in FIG. 2 was prepared using the rotor magnet. The hard disk drive device was prepared by replacing the internal space with helium and by leaving the internal space as air.

### 2. Operation Test

Before starting the test, the back electromotive force constant of the hard disk drive device was measured. Then, the hard disk drive device was operated in an oven set at 70° C. After 5000 hours, the hard disk drive device was removed and the back electromotive force constant was measured. The rate of change in back electromotive force constant before and after the test, was defined as a demagnetizing factor. The method of calculating the demagnetizing factor is as following Equation 1:

$$\begin{matrix}\text{Demagnetizing factor = ((Back electromotive force constant after specified time) - (Back} \\ \text{electromotive force constant before start of test)) / (Back electromotive force constant before} \\ \text{start of test)} \times \text{100\%}\end{matrix}$$

### 3. Test Results

The demagnetizing factors obtained are shown in Table 1. The hard disk drive device with air sealed was used as Comparative Example 1, the results of obtaining a demagnetizing factor smaller than the demagnetizing factor in Comparative Example 1 were defined as Examples 1 to 4, and the others were defined as Comparative Examples 2 to 4.

Table 1

| | Internal environment of HDD | Content of Nb (mass%) | Magnet Thickness t (mm) | Magnet Density d (g/cm³) | Demagnetizing factor |
|---|---|---|---|---|---|
| Example 1 | helium | | 1.0 | 5.85 | -1.1% |
| Example 2 | helium | | 1.0 | 6.00 | -1.6% |
| Example 3 | helium | 2.0 | 1.0 | 6.00 | -0.8% |
| Example 4 | helium | 2.0 | 0.9 | 6.10 | -1.2% |
| Comparative Example 1 | air | | 0.9 | 5.85 | -1.7% |
| Comparative Example 2 | helium | | 0.9 | 5.85 | -2.4% |
| Comparative Example 3 | helium | | 1.0 | 6.10 | -2.2% |
| Comparative Example 4 | helium | 1.0 | 0.9 | 6.10 | -2.0% |

As illustrated in Table 1, in Comparative Examples with air sealed, the thickness of the rotor magnet is less than 1.0 mm, the density of the rotor magnet is 5.6 to 6.0 g/cm³, and the demagnetizing factor is -1.7%. Example 1 to 4 and Comparative Example 2 to 4 are evaluated based on these conditions and results.

0032] In Comparative Example 2, as compared with Comparative Example 1, the sealed gas was changed from air to helium, and a sealed space was formed without air flow with the outside, but the demagnetizing factor was greatly increased to -2.4%. In Comparative Example 3, although the thickness of the rotor magnet is in the range of 1.0 to 1.4 mm, the density exceeds 6.0 g/cm³, and thus the demagnetizing factor is -2.2%, larger than the demagnetizing factor in Comparative Example 1.

In Example 1, the thickness of the rotor magnet was in the range of 1.0 to 1.4 mm, the density was in the range of 5.6 to 6.0 g/cm³, and thus the demagnetizing factor was -1.1%, greatly reduced compared to the demagnetizing factor in Comparative Example 1. In Example 2, the thickness of the rotor magnet was in the range of 1.0 to 1.4 mm, the density was in the range of 5.6 to 6.0 g/cm³, but the density was the upper limit value, and thus the demagnetizing factor was -1.6 and slightly increased compared to the demagnetizing factor in Example 1.

0034] In Example 3, the thickness of the rotor magnet was in the range of 1.0 to 1.4 mm, the density was in the range of 5.6 to 6.0 g/cm³, the content of Nb was 2.0 mass%, and thus the demagnetizing factor was -0.8%, the lowest. In Example 4, the thickness of the rotor magnet was less than 1.0, the density was more than 6.0 g/cm³, but the content of Nb was 2.0 mass% of Nb was contained, and thus the demagnetizing factor was -1.2%, a value equivalent to the value in Example 1. On the other hand, in Comparative Example 4, the thickness of the rotor magnet is less than 1.0, the density is more than 6.0 g/cm³, the content of Nb is less than 1.5 mass%, and thus the demagnetizing factor is 2.0%, more than the demagnetizing factor in Comparative Example 1.

The disclosure can be used for a spindle motor and a hard disk drive device and especially can be suitably used for a hard disk drive device with a low-density gas sealed.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A spindle motor configured to be used for a hard disk drive device with a gas having a density lower than a density of air sealed in an internal space, the spindle motor comprising
a rotor magnet, wherein
the rotor magnet has a radial thickness of 1.0 to 1.4 mm, and
the rotor magnet has a density of 5.6 to 6.0 g/cm³.

2. The spindle motor according to claim 1, wherein
the rotor magnet is an Nd—Fe—B—Nb—based magnet, and
Nb contained in the rotor magnet is in a ratio of 1.5 to 3.0 mass% to a total mass of the rotor magnet.

3. A spindle motor configured to be used for a hard disk drive device with a gas having a density lower than a density of air sealed in an internal space, the spindle motor comprising
a rotor magnet, wherein
the rotor magnet is an Nd—Fe—B—Nb—based magnet, and
Nb contained in the rotor magnet is in a ratio of 1.5 to 3.0 mass% to a total mass of the rotor magnet.

4. The spindle motor according to claim 1, wherein
a surface of the rotor magnet is covered with a coating film, and the coating film has a thickness of 10 to 35 µm.

5. The spindle motor according to claim 4, wherein
the coating film has a thickness of 15 to 25 µm.

6. A hard disk drive device comprising the spindle motor according to claim 1, wherein
a gas having a density lower than a density of air is sealed in an internal space.
